(19) United States
(12) Patent Application Publication
(10) Pub. No.: US 2019/0361999 A1
(43) Pub. Date: Nov. 28, 2019

(54) DATA ANALYSIS OVER THE COMBINATION OF RELATIONAL AND BIG DATA

(71) Applicant: MICROSOFT TECHNOLOGY LICENSING, LLC, Redmond, WA (US)

(72) Inventors: Stanislav A. Oks, Kirkland, WA (US); Travis Austin Wright, Issaquah, WA (US); Jasraj Uday Dange, Redmond, WA (US); Jarupat Jisarojito, Redmond, WA (US); Weiyun Huang, Bellevue, WA (US); Stuart Padley, Seattle, WA (US); Umachandar Jayachandran, Sammamish, WA (US)

(21) Appl. No.: 16/169,925

(22) Filed: Oct. 24, 2018

Related U.S. Application Data
(60) Provisional application No. 62/675,570, filed on May 23, 2018.

(51) Int. Cl. G06F 16/22; G06F 15/18

(52) U.S. Cl. CPC G06F 17/30312; G06F 15/18; G06F 17/30545; G06F 17/30557

(57) ABSTRACT

Processing a database query over a combination of relational and big data includes receiving the database query at a master node or a compute node within a database system. Based on receiving the database query, a storage pool within the database system is identified. The storage pool comprises a plurality of storage nodes, each storage node including a relational engine, a big data engine, and big data storage. The database query is processed over a combination of relational data stored within the database system and big data stored at the big data storage of at least one of the plurality of storage nodes. The relational data could be stored at the master node and/or at one or more data nodes. An artificial intelligence model and/or machine learning model might also be trained and/or scored using a combination of relational data and big data.

### CROSS-REFERENCE TO RELATED APPLICATION

This application claims priority to, and the benefit of, U.S. Provisional Patent Application No. 62/675,570, filed May 23, 2018, and titled “DATA ANALYSIS OVER THE COMBINATION OF RELATIONAL AND BIG DATA,” the entire contents of which are incorporated by reference herein in their entirety.

### BACKGROUND

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. For example, computer systems are commonly used to store and process large volumes of data using different forms of databases.

Databases can come in many forms. For example, one family of databases follow a relational model. In general, data in a relational database is organized into one or more tables (or “relations”) of columns and rows, with a unique key identifying each row. Rows are frequently referred to as records or tuples, and columns are frequently referred to as attributes. In relational databases, each table has an associated schema that represents the fixed attributes and data types that the items in the table will have. Virtually all relational database systems use variations of the Structured Query Language (SQL) for querying and maintaining the database. Software that parses and processes SQL is generally known as an SQL engine. There are a great number of popular relational database engines (e.g., MICROSOFT SQL SERVER, ORACLE, MYSQL POSTGRESQL, DB2, etc.) and SQL dialects (e.g., T-SQL, PL/SQL, SQL/PSM, PL/PGSQL, SQL PL, etc.).

The proliferation of the Internet and of vast numbers of network-connected devices has resulted in the generation and storage of data on a scale never before seen. This has been particularly precipitated by the widespread adoption of social networking platforms, smartphones, wearables, and Internet of Things (IoT) devices. These services and devices tend to have the common characteristic of generating a nearly constant stream of data, whether that be due to user input and user interactions, or due to data obtained by physical sensors. This unprecedented generation of data has opened the doors to entirely new opportunities for processing and analyzing vast quantities of data, and to observe data patterns on even a global scale. The field of gathering and maintaining such large data sets, including the analysis thereof, is commonly referred to as “big data.”

In general, the term “big data” refers to data sets that are voluminous and/or are not conducive to being stored in rows and columns. For instance, such data sets often comprise blobs of data like audio and/or video files, documents, and other types of unstructured data. Even when structured, big data frequently has an evolving or jagged schema. Traditional relational database management systems (DBMSs), may be inadequate or sub-optimal for dealing with “big data” data sets due to their size and/or evolving/jagged schemas.

As such, new families of databases and tools have arisen for addressing the challenges of storing and processing big data. For example, APACHE HADOOP is a collection of software utilities for solving problems involving massive amounts of data and computation. HADOOP includes a storage part, known as the HADOOP Distributed File System (HDFS), as well as a processing part that uses new types of programming models, such as MapReduce, Tez, Spark, Impala, Kudu, etc.

The HDFS stores large and/or numerous files (often totaling gigabytes to petabytes in size) across multiple machines. The HDFS typically stores data that is unstructured or only semi-structured. For example, the HDFS may store plaintext files, Comma-Separated Values (CSV) files, JavaScript Object Notation (JSON) files, Avro files, Sequence files, Record Columnar (RC) files, Optimized RC (ORC) files, Parquet files, etc. Many of these formats store data in a columnar format, and some feature additional metadata and/or compression.

As mentioned, big data processing systems introduce new programming models, such as MapReduce. A MapReduce program includes a map procedure, which performs filtering and sorting (e.g., sorting students by first name into queues, one queue for each name), and a reduce method, which performs a summary operation (e.g., counting the number of students in each queue, yielding name frequencies). Systems that process MapReduce programs generally leverage multiple computers to run these various tasks in parallel and manage communications and data transfers between the various parts of the system. An example engine for performing MapReduce functions is HADOOP YARN (Yet Another Resource Negotiator).

Data in HDFS is commonly interacted with/managed using APACHE SPARK, which provides Application Programming Interfaces (APIs) for executing “jobs” which can manipulate the data (insert, update, delete) or query the data. At its core, SPARK provides distributed task dispatching, scheduling, and basic input/output functionalities, exposed through APIs for interacting with external programming languages, such as Java, Python, Scala, and R.

Given the maturity of, and existing investment in database technology many organizations may desire to process/analyze big data using their existing relational DBMSs, leveraging existing tools and know-how. This may mean importing large amounts of data from big data stores (e.g., such as HADOOP's HDFS) into an existing DBMS. Commonly, this is done using custom-coded extract, transform, and load (ETL) programs that extract data from big data stores, transform the extracted data into a form compatible with traditional data stores, and load the transformed data into an existing DBMS.

The import process requires not only significant developer time to create and maintain ETL programs (including adapting them as schemas change in the DBMS and/or in the big data store), but it also requires significant time—including both computational time (e.g., CPU time) and elapsed real time (e.g., “wall-clock” time)—and communications bandwidth to actually extract, transform, and transfer the data.

Given the dynamic nature of big data sources (e.g., continual updates from IoT devices), use of ETL to import big data into a relational DBMS often means that the data is actually out of date/irrelevant by the time it makes it from the big data store into the relational DBMS for processing/analysis. Further, use of ETL leads to data duplication, an increased attack surface, difficulty in creating/enforcing a consistent security model (i.e., across the DBMS and the big data store(s)), geo-political compliance issues, and difficulty in complying with data privacy laws, among other problems.

### BRIEF SUMMARY

At least some embodiments described herein incorporate relational databases and big data databases—including integrating both relational (e.g., SQL) and big data (e.g., APACHE SPARK) database engines—into a single unified system. Such embodiments avoid the need to use ETL techniques to import big data into a relational DBMS or export data from a relational DBMS to big data formats, reducing both the computational time and the communications bandwidth required to operate on big data within a relational DBMS.

Such embodiments also enable data analysis to be performed over the combination of relational data and big data. For example, a single SQL query statement can operate on both relational and big data or on either relational or big data individually. In general, the systems described herein appear to external consumers to be a single DBMS that uses SQL dialect(s) typical to that DBMS. As such, an external consumer can operate on big data using familiar SQL statements, even though that consumer is unaware of the actual physical location of the big data itself, and the more typical mechanisms (e.g., SPARK jobs) for interacting with big data. Additionally, embodiments can train and score artificial intelligence (AI) and/or machine learning (ML) models over the combination of relational and big data.

In some embodiments, systems, methods, and computer program products for processing a database query over a combination of relational and big data include receiving a database query at a master node or a compute node within a database system. Based on receiving the database query, a storage pool within the database system is identified. The storage pool comprises a plurality of storage nodes, each storage node including a relational engine, a big data engine, and big data storage. The database query is processed over a combination of relational data stored within the database system and big data stored at the big data storage of at least one of the plurality of storage nodes.

In additional, or alternative, embodiments, systems, methods, and computer program products for training an AI/ML model over a combination of relational and big data include receiving, at a master node within a database system, a script for creating at least one of an AI model or a ML model. Based on receiving the script, a storage pool within the database system is identified. The storage pool comprises a plurality of storage nodes, each storage node including a relational engine, a big data engine, and big data storage. The script is processed over a combination of relational data stored within the database system and big data stored at the big data storage of at least one of the plurality of storage nodes to create the AI/ML model. Then, based on a database query received at the master node, the AI/ML model is scored against data stored within or sent to the database system.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example of a database system that enables data analysis to be performed over the combination of relational data and big data;

FIG. 2A illustrates an example database system that demonstrates training and scoring of AI/ML models;

FIG. 2B illustrates an example database system that demonstrates training and scoring of AI/ML models and in which a copy of an AI/ML model is stored at compute and data pools;

FIG. 3 illustrates a flow chart of an example method for processing a database query over a combination of relational and big data; and

FIG. 4 illustrates a flow chart of an example method for training an AI/ML model over a combination of relational and big data.

### DETAILED DESCRIPTION

At least some embodiments described herein incorporate relational databases and big data databases—including integrating both relational (e.g., SQL) and big data (e.g., APACHE SPARK) database engines—into a single unified system. Such embodiments avoid the need to use ETL techniques to import big data into a relational DBMS or export data from a relational DBMS to big data formats, reducing both the computational time and the communications bandwidth required to operate on big data within a relational DBMS.

Such embodiments also enable data analysis to be performed over the combination of relational data and big data. For example, a single SQL query statement can operate on both relational and big data or on either relational or big data individually. In general, the systems described herein appear to external consumers to be a single DBMS that uses SQL dialect(s) typical to that DBMS. As such, an external consumer can operate on big data using familiar SQL statements, even though that consumer is unaware of the actual physical location of the big data itself, and the more typical mechanisms (e.g., SPARK jobs) for interacting with big data. Additionally, embodiments can train and score AI/ML models over the combination of relational and big data.

As will be appreciated in view of the disclosure herein, the embodiments described represent significant advancements in the technical field of databases. For example, by supporting big data engines and big data storage (i.e., in storage pools) as well as traditional database engines, the embodiments herein bring traditional database functionality together with big data functionality within a single managed system for the first time, reducing the number of computer systems that need to be deployed and managed and providing for queries and AI/ML scoring and training over the combination of traditional and big data that were not possible prior to these innovations. Additionally, since fewer computer systems are needed to manage relational and big data, the need to continuously transfer and convert data between relational and big data systems is eliminated.

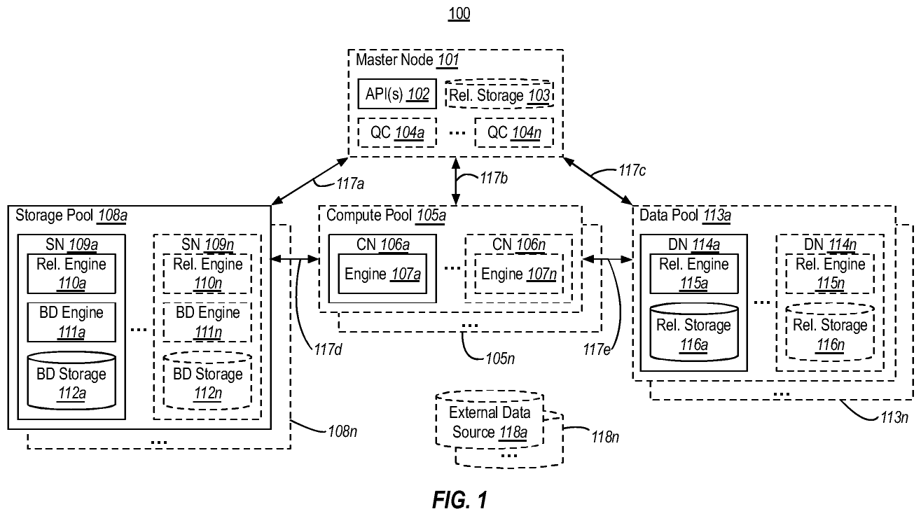

FIG. 1 illustrates an example of a database system 100 that enables data analysis to be performed over the combination of relational data and big data. As shown, database system 100 might include a master node 101. If included, the master node 101 is an endpoint that manages interaction of the database system 100 with external consumers (e.g., other computer systems, software products, etc., not shown) by providing API(s) 102 to receive and reply to queries (e.g., SQL queries). As such, master node 101 can initiate processing of queries received from consumers using other elements of database system 100 (i.e., compute pool(s) 105, storage pool(s) 108, and/or data pool(s) 113, which are described later). Based on obtaining results of processing of queries, the master node 101 can send results back to requesting consumer(s).

In some embodiments, master node 101 could appear to consumers to be a standard relational DBMS. Thus, API(s) 102 could be configured to receive and respond to traditional relational queries. In these embodiments, the master node 101 could include a traditional relational DBMS engine. However, in addition, master node 101 might also facilitate big data queries (e.g., SPARK or MapReduce jobs). Thus, API(s) 102 could also be configured to receive and respond to big data queries. In these embodiments, the master node 101 could also include a big data engine (e.g., a SPARK engine). Regardless of whether master node 101 receives a traditional DBMS query or a big data query, the master node 101 is enabled to process that query over a combination of relational data and big data. While database system 100 provides expandable locations for storing DBMS data (e.g., in data pools 113, as discussed below), it is also possible that master node 101 could include its own relational storage 103 as well (e.g., for storing relational data).

As shown, database system 100 can include one or more compute pools 105 (shown as 105a-105n). If present, each compute pool 105 includes one or more compute nodes 106 (shown as 106a-106n). The ellipses within compute pool 105a indicate that each compute pool 105 could include any number of compute nodes 106 (i.e., one or more compute nodes 106). Each compute node can, in turn, include a corresponding compute engine 107a (shown as 107a-107n).

If one or more compute pools 105 are included in database system 100, the master node 101 can pass a query received at API(s) 102 to at least one compute pool 105 (e.g., arrow 117b). That compute pool (e.g., 105a) can then use one or more of its compute nodes (e.g., 106a-106n) to process the query against storage pools 108 and/or data pools 113 (e.g., arrows 117d and 117e). These compute node(s) 106 process this query using their respective compute engine 107. After the compute node(s) 106 complete processing of the query, the selected compute pool(s) 105 pass any results back to the master node 101.

By including compute pools 105, the database system 100 can enable query processing capacity to be scaled up efficiently (i.e., by adding new compute pools 105 and/or adding new compute nodes 106 to existing compute pools). The database system 100 can also enable query processing capacity to be scaled back efficiently (i.e., by removing existing compute pools 105 and/or removing existing compute nodes 106 from existing compute pools).

In embodiments, if the database system 100 lacks compute pool(s) 105, then the master node 101 may itself handle query processing against storage pool(s) 108, data pool(s) 113, and/or its local relational storage 103 (e.g., arrows 117a and 117c). In embodiments, if one or more compute pools 105 are included in database system 100, these compute pool(s) could be exposed to external consumers directly. In these situations, an external consumer might bypass the master node 101 altogether (if it is present), and initiate queries on those compute pool(s) directly. As such, it will be appreciated that the master node 101 could potentially be optional. If the master node 101 and a plurality of compute pools 105 are present, the master node 101 might receive results from each compute pool 105 and join/aggregate those results to form a complete result set.

As shown, database system 100 includes one or more storage pools 108 (shown as 108a-108n). Each storage pool 108 includes one or more storage nodes 109 (shown as 109a-109n). The ellipses within storage pool 108a indicate that each storage pool could include any number of storage nodes (i.e., one or more storage nodes).

As shown, each storage node 109 includes a corresponding relational engine 110 (shown as 110a-110n), a corresponding big data engine 111 (shown as 111a-111n), and corresponding big data storage 112 (shown as 112a-112n). For example, the big data engine 111 could be a SPARK engine, and the big data storage 112 could be HDFS storage. Since storage nodes 109 include big data storage 112, data are stored at storage nodes 109 using “big data” file formats (e.g., CSV, JSON, etc.), rather than more traditional relational or non-relational database formats.

Notably, however, storage nodes 109 in each storage pool 108 include both a relational engine 110 and a big data engine 111. These engines 110, 111 can be used—singly or in combination—to process queries against big data storage 112 using relational database queries (e.g., SQL queries) and/or using big data queries (e.g., SPARK queries). Thus, the storage pools 108 allow big data to be natively queried with a relational DBMS's native syntax (e.g., SQL), rather than requiring use of big data query formats (e.g., SPARK). For example, storage pools 108 could permit queries over data stored in HDFS-formatted big data storage 112, using SQL queries that are native to a relational DBMS. This means that big data can be queried/processed together—making big data analysis fast and readily accessible to a broad range of DBMS administrators/developers.

Further, because storage pools 108 enable big data to reside natively within database system 100, they eliminate the need to use ETL techniques to import big data into a DBMS, eliminating the drawbacks described in the Background (e.g., maintaining ETL tasks, data duplication, time/bandwidth concerns, security model difficulties, data privacy concerns, etc.).

As shown, database system 100 can also include one or more data pools 113 (shown as 113a-113n). If present, each data pool 113 includes one or more data nodes 114 (shown as 114a-114n). The ellipses within data pools 113aindicate that each data pool could include any number of data nodes (i.e., one or more data nodes). As shown, each data node 113 includes a corresponding relational engine 115 (shown as 115a-115n) and corresponding relational storage 116 (shown as 116a-116n). Thus, data pools 113 can be used to store and query relational data stores, where the data is partitioned across individual relational storage 116 within each data node 113.

By supporting the creation and use of storage pools 108 and data pools 113, the database system 100 can enable data storage capacity to be scaled up efficiently, both in terms of big data storage capacity and relational storage capacity (i.e., by adding new storage pools 108 and/or nodes 109, and/or by adding new data pools 113 and/or nodes 113). The database system 100 can also enable data storage capacity to be scaled back efficiently (i.e., by removing existing storage pools 108 and/or nodes 109, and/or by removing existing data pools 113 and/or nodes 113).

Using the relational storage 103, storage pools 108, and/or data pools 113, the master node 101 might be able to process a query (whether that be a relational query or a big data query) over a combination of relational data and big data. Thus, for example, a single query can be processed over any combination of (i) relational data stored at the master node 101 in relational storage 103, (ii) big data stored in big data storage 112 at one or more storage pools 108, and (iii) relational data stored in relational storage 116 at one or more data pools 113. This may be accomplished, for example, by the master node 101 creating an “external” table over any data stored at relational storage 103, big data storage 112, and/or relational storage 116. An external table is a logical table that represents a view of data stored in these locations. Then, a single query, sometimes referred to as a global query, can then be processed against a combination of these external tables.

In some embodiments, the master node 101 can translate received queries into different query syntaxes. For example, FIG. 1 shows that in the master node 101 might include one or more query converters 104 (shown as 104a-104n). These query converters 104 can enable the master node 101 to interoperate with database engines having a different syntax than API(s) 102. For example, the database system 100 might be enabled to interoperate with one or more external data sources 118 (shown as 118a-118n) that could use a different query syntax than API(s) 102. In this situation, the query converters 104 could receive queries targeted at one or more of those external data sources 118 in one syntax (e.g., T-SQL), and could convert those queries into syntax appropriate to the external data sources 118 (e.g., PL/SQL, SQL/PSM, PL/PGSQL, SQL PL, REST API calls, etc.). The master node 101 could then query the external data sources 118 using the translated query. It might even be possible that the storage pools 108 and/or the data pools 113 include one or more engines (e.g., 110, 113, 115) that use a different query syntax than API(s) 102. In these situations, query converters 104 can convert incoming queries into appropriate syntax for these engines prior to the master node 101 initiating a query on these engines. Database system 100 might, therefore, be viewed as a “poly-data source” since it is able to “speak” multiple data source languages. Notably, use of query converters 104 can provide flexible extensibility of database system 100, since it can be extended to use new data sources without the need to rewrite or otherwise customize those data sources.

A database may execute scripts (e.g., written in R, Python, etc.) that perform analysis over data stored in the DBMS. In many instances, these scripts are used to analyze relational data stored in the DBMS, in order to develop/train artificial intelligence (AI)/machine learning (ML) models. Similar to how database system 100 enables a query to be run over a combination of relational and big data, database system 100 can also enable such scripts to be run over the combination of relational and big data to train AI and/or ML models. Once an AI/ML model is trained, scripts can also be used to “score” the model. In the field of ML, scoring is also called prediction, and is the process of new generating values based on a trained ML model, given some new input data. These newly generated values can be sent to an application that consumes ML results or can be used to evaluate the accuracy and usefulness of the model.

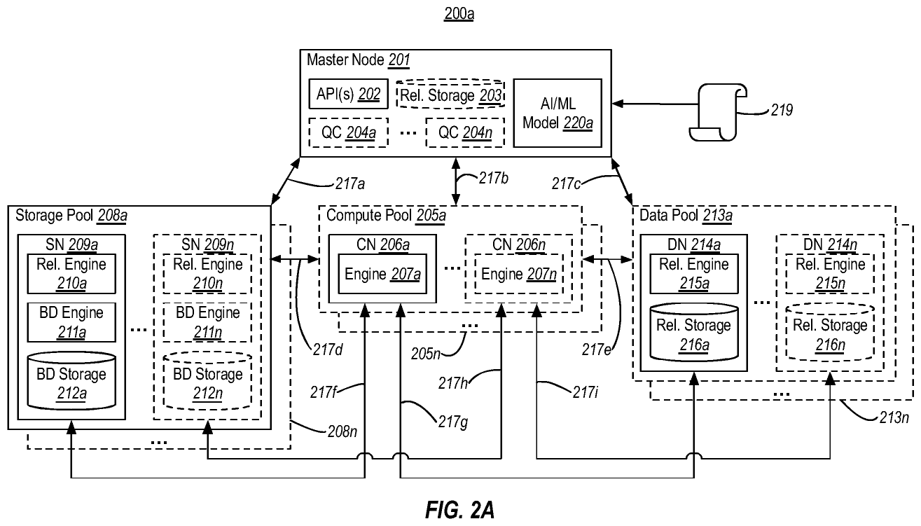

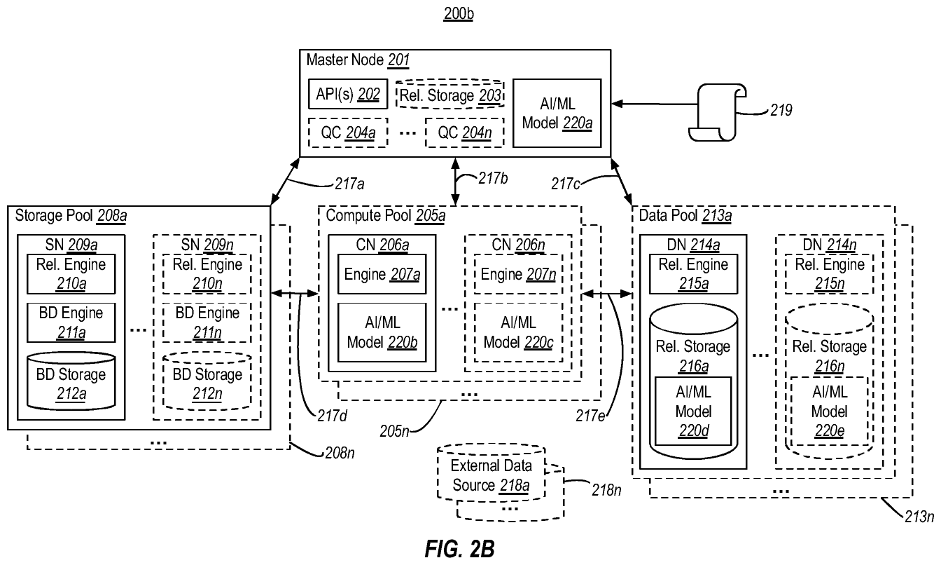

FIGS. 2A and 2B illustrate example database systems 200a/200b that are similar to the database system 100 of FIG. 1, but which demonstrate training and scoring of AI/ML models. The numerals (and their corresponding elements) in FIGS. 2A and 2B correspond to similar numerals (and corresponding elements) from FIG. 1. For example, compute pool 205a corresponds to compute pool 105a, storage pool 208a corresponds to storage pool 108a, and so on. As such, all of the description of database system 100 of FIG. 1 applies to database systems 200a and 200b of FIGS. 2A and 2B. Likewise, all of the additional description of database systems 200a and 200b of FIGS. 2A and 2B could be applied to database system 100 of FIG. 1.

As shown in FIG. 2A, the master node 201 can receive a script 219 from an external consumer. Based on processing this script 219 (e.g., using the master node 201, compute pool 205a, storage pool 208a, and/or the data pool 213a), the database management system 200 can train one or more AI/ML models 220a over the combination of relational and big data. The master node 201 and/or compute pool 205a could also be used to score an AI/ML model 220a, once trained, leveraging the combination of relational and big data as inputs.

Processing this script 219 could proceed in several manners. In a first example, based on receipt of script 219, the master node 201 could directly execute one or more queries against the storage pool 208a and/or the data pool 212a (e.g., arrows 217a and 217c), and receive results of the query back at the master node 201. Then, the master node 201 can execute the script 219 against these results to train the AI/ML model 220a.

In a second example, the master node 201 could leverage one or more compute pools (e.g., compute pool 205a) to assist in query processing. For example, based on receipt of script 219, the master node 201 could request that compute pool 205a execute one or more queries against storage pool 208a and/or data pool 213a. Compute pool 205a could then use its various compute nodes (e.g., compute node 206a) to perform one or more queries against the storage pool 208a and/or the data pool 213a. In some embodiments, these queries could be executed in a parallel and distributed manner by compute nodes 206, as shown by arrows 217f-217i. For example, each compute node 206 in compute pool 205 could query a different storage node 209 in storage pool 208 and/or a different data node 214 in data pool 213. In some embodiments, this may include the compute nodes 206 coordinating with the relational and/or big data engines 210/211 at the storage nodes 209, and/or the compute nodes 206 coordinating with the relational engines 215 at the data nodes 214.

In some embodiments, these engines 210/211/215 at the storage and/or data nodes 209/214 are used to perform a filter portion of a requested query (e.g., a “WHERE” clause in an SQL query). Each node involved then passes any data stored at the node, and that matches the filter, up to the requesting compute node 206. The compute nodes 206 in a compute pool 205 then operate together to aggregate/assemble the data received from the various storage and/or data nodes 209/214, in order to form one or more results for the one or more queries originally requested by the master node 201. The compute pool 205 passes these result(s) back to the master node 201, which processes the script 219 against the result(s) to form AI/ML model 220a. Thus, in this example, query processing has been distributed across compute nodes 205, reducing the load on the master node 201 when forming the AI/ML model 220a.

In a third example, the master node 201 could leverage one or more compute pools 205 to assist in both query and script processing. For example, the master node 201 could not only request query processing by compute pool 205a, but it could also push the script 219 to compute pool 205a as well. In this example, distributed query processing could proceed in substantially the manner described in the second example above. However, rather than passing the query result(s) back to the master node 201 for processing using the script 219, some embodiments could do such script processing at compute pool 205a as well. For example, each compute node 206 could process its subset of the overall query result using the script 219, forming a subset of the overall AI/ML model 220a. The compute nodes 206 could then assemble these subsets to create the overall AI/ML model 220a and return AI/ML model 220a to the master node 201. Alternatively, the compute nodes 206 could return these subsets of the overall AI/ML model 202a to the master node 201, and the master node 201 could assemble them to create AI/ML model 220a.

In a fourth example, the master node 201 might even push the script processing all the way down to the storage pools 208 and/or the data pools 213. Thus, each storage and/or data node 209/214 may perform a filter operation on the data stored at the node, and then each storage and/or data node 209/214 may perform a portion of script processing against that filtered data. The storage/data 209/214 nodes could then return one or both of the filtered data and/or a portion of an overall AI/ML model 220a to a requesting compute node 206. The compute nodes 206 could then aggregate the query results and/or the AI/ML model data, and the compute pool 205 could return the query results and/or the AI/ML model 220a to the master node 201.

While FIG. 2A shows the resulting AI/ML model 220a as being stored at the master node, in embodiments the model could additionally, or alternatively, be stored in compute pools 205 and/or data pools 213. For example, in FIG. 2B each data node 214 includes a copy of the AI/ML model (shown as 220d and 220e). In implementations, when an AI/ML model (e.g., AI/ML model 220d) exists at data node (e.g., data node 214a), that data node can score incoming data against the AI/ML model as is it loaded into the data pool (e.g., data pool 213a). Thus, for example, if data contained in a query received from an external consumer is inserted into relational storage 216a, data node 214a could score that data using AI/ML model as it is inserted into relational storage 216a. In another example, if data is loaded from an external data source 218 into relational storage 216a, data node 214a could score that data using AI/ML model as it is inserted into relational storage 216a.

In addition, in FIG. 2B each compute node 206 includes a copy of the AI/ML model (shown as 220b and 220c). In implementations, when an AI/ML model (e.g., AI/ML model 220b) exists at compute node (e.g., compute node 206a), that compute node can score against data in a partitioned manner. For example, an external consumer might issue a query requesting a batched scoring of AI/ML model 220a against a partitioned data set. The partitioned data set could be partitioned across one or more storage nodes/pools, one or more data nodes/pools, and/or one or more external data sources 218.

As a result of the query, the master node 201 could push the AI/ML model 220a to a plurality of compute nodes and/or pools (e.g., AI/ML model 220b at compute node 206a and AI/ML model 220c at compute node 206n). Each compute node 206 can then issue a query against a respective data source and receive a partitioned result set back. For example, compute node 206a might issue a query against data node 214a and receive a result set back from data node 214a, and compute node 206n might issue a query against data node 214n and receive a result set back from data node 214n. Each compute node can then score its received partition of data against the AI/ML model (e.g., 220b/220c) and return a result back to the master node 201. The result could include the scoring data only, or it could include the scoring results as well as the queried data itself. In implementations, compute pool 205a might aggregate the results prior to returning them to the master node 201, or the master node 201 could receive individual results from each compute node 206 and aggregate them itself.

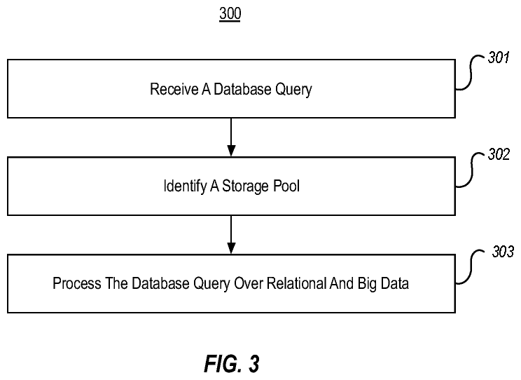

While the foregoing description has focused on example systems, embodiments herein can also include methods that are performed within those systems. FIG. 3, for example, illustrates a flow chart of an example method 300 for processing a database query over a combination of relational and big data. In embodiments, method 300 could be performed, for example, within database systems 100/200a/200b of FIGS. 1, 2A, and 2B.

As shown, method 300 includes an act 301 of receiving a database query. In some embodiments, act 301 comprises receiving a database query at a master node or a compute node within a database system. For example, an external consumer could send a query to master node 101 or, if the external consumer is aware of compute pools 105, the external consumer could send the query to a particular compute pool (e.g., compute pool 105a). Thus, depending on which nodes/pools are available within database system 100, and depending on knowledge of external consumers, a database query could be received by master node 101 or it could be received by a compute node 106. As was discussed, when the database query is received at the master node 101, the master node 101 may choose to pass that database query to a compute pool 105.

Method 300 also includes an act 302 of identifying a storage pool. In some embodiments, act 302 comprises, based on receiving the database query, identifying a storage pool within the database system, the storage pool comprising a plurality of storage nodes, each storage node including a relational engine, a big data engine, and big data storage. For example, if the database query was received at the master node 101, the master node 101 could identify storage pool 108a. Alternatively, if the database query was received at compute pool 105a, or if the query was received by the master node 101 and passed to the compute pool 105a, then one or more of a plurality of compute nodes 106 could identify storage pool 108a.

Method 300 also includes an act 303 of processing the database query over relational and big data. In some embodiments, act 303 comprises processing the database query over a combination of relational data stored within the database system and big data stored at the big data storage of at least one of the plurality of storage nodes. For example, if the database query was received at the master node 101, the master node 101 could process the database query over big data stored in big data storage 112 at one or more storage nodes 109. Alternatively, if the database query was received at compute pool 105a, or if the query was received by the master node 101 and passed to compute pool 105a, then one or more of a plurality of compute nodes 106 could process the database query over big data stored in big data storage 112 at one or more storage nodes 109.

The relational data could be stored in (and queried from) one or more of several locations. For example, the master node 101 could store the relational data in relational storage 103. Additionally, or alternatively, the database system 100 could include a data pool 113a comprising a plurality of data nodes 114, each data node including a relational engine 115 and relational data storage 116, with the relational data being stored in the relational data storage 116 at one or more of the data nodes 114. Additionally, or alternatively, the database system 100 could be connected to one or more external data sources 118, and the relational data could be stored in these data source(s) 118.

Query processing could proceed in a distributed manner. In one example, for instance, a first compute node (e.g., compute node 106a) could query a storage node (e.g., storage node 109a) for the big data, and a second compute node (e.g., compute node 106n) could query a data node (e.g., data node 114a) for the relational data.

Method 300 can also operate to process AI/ML models and scripts. For example, the master node could receive a script for creating an AI model and/or an ML model, and the computer system could process the script over query results resulting from processing the database query over a combination of relational data and big data, in order to train or score the AI/ML model.

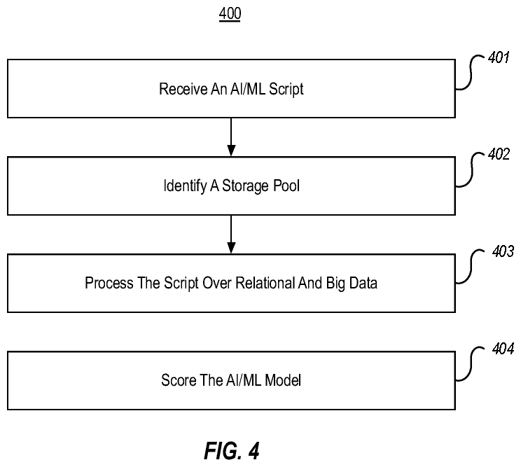

In order to further illustrate how AI/ML models could be trained/scored, FIG. 4 illustrates a flow chart of an example method 400 for training an AI/ML model over a combination of relational and big data. In embodiments, method 400 could be performed, for example, within database systems 100/200a/200b of FIGS. 1, 2A, and 2B.

As shown, method 400 includes an act 401 of receiving an AI/ML script. In some embodiments, act 401 comprises receiving, at a master node within a database system, a script for creating at least one of an AI model or an ML model (i.e., AI/ML model). For example, as shown in FIGS. 2A/2B, master node 201 could receive script 219, which, when processed, can be used to can train/create AI/ML models (e.g., 220a-220e). Similar to method 300, master node 201 might pass the script 219 to one or more compute pools 205 for processing.

Method 400 also includes an act 402 of identifying a storage pool. In some embodiments, act 401 comprises, based on receiving the script, identifying a storage pool within the database system, the storage pool comprising a plurality of storage nodes, each storage node including a relational engine, a big data engine, and big data storage. For example, the master node 201 could identify storage pool 208a. Alternatively, if the master node 101 passed the script to compute pool 205a, one or more of a plurality of compute nodes 206 could identify storage pool 208a.

Method 400 also includes an act 403 of processing the script over relational and big data. In some embodiments, act 401 comprises processing the script over a combination of relational data stored within the database system and big data stored at the big data storage of at least one of the plurality of storage nodes to create the AI/ML model. For example, the master node 101 could process the script 219 over big data stored in big data storage 212 at one or more storage nodes 109. Alternatively, if the script was passed to compute pool 205a, then one or more of a plurality of compute nodes 206 could process the database query over big data stored in big data storage 212 at one or more storage nodes 109. Similar to method 300, the relational data could be stored in (and queried from) the master node 201 (i.e., relational storage 203), data pool 213 (i.e., relational storage 216), and/or external data sources 218. Any number of components could participate in processing the script (e.g., storage nodes, compute nodes, and/or data nodes).

Method 400 also includes an act 404 of scoring the AI/ML script. In some embodiments, act 401 comprises, based on a database query received at the master node, scoring the AI/ML model against data stored within the database system. For example, based on a subsequent database query, the master node 201 and/or the compute nodes 206 could score the AI/ML model 220a over data obtained from relational storage 203, big data stored in storage pool(s) 208, relational data stored in data pool(s) 213, and/or data stored in external data source(s) 218.

As was discussed, the AI/ML script could be stored at the master node 201 (i.e., AI/ML model 220a), and potentially at one or more data nodes 214 (i.e., AI model 220d/220e). Additionally, the AI/ML script could be pushed to compute nodes 206 during a scoring request (i.e., AI model 220b/220c). Thus, for example, scoring the AI/ML model against data stored within the database system could comprise a data node (e.g., 214a) scoring the AI/ML model (e.g., 220d) against data that is being stored at the data node (e.g., in relational storage 216a).

In another example, scoring the AI/ML model against data stored within the database system could comprise pushing the AI/ML model to a compute node (e.g., 206a), with the compute node scoring the AI/ML model (e.g., 220b) against a partitioned portion of data received at the compute node.

It will be appreciated that methods 300/400 can be combined. For example, the debase query in method 300 could correspond to the database query in method 400 that results in scoring of an AI/ML model.

Accordingly, the embodiments herein enable data analysis to be performed over the combination of relational data and big data. This may include performing relational (e.g., SQL) queries over both relational data (e.g., data pools) and big data (e.g., storage pools). This may also include executing AI/ML scripts over the combination of relational data and big data in order to train AI/ML models, and/or executing AI/ML scripts using a combination of relational data and big data as input in order to score an AI/ML model. Using compute, storage, and/or data pools, such AI/ML script processing can be performed in a highly parallel and distributed manner, with different portions of query and/or script processing being performed at different compute, storage, and/or data nodes. Any of the foregoing can be performed over big data stored natively within a database management system, eliminating the need to maintain ETL tasks to import data from a big data store to a relational data store, or export data from a relational store to a big data store and eliminating all the drawbacks of using ETL tasks.

It will be appreciated that embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “MC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A computer system, comprising:
one or more processors; and
one or more computer-readable media having stored thereon computer-executable instructions that, when executed by the one or more processors, cause the computer system to perform the following:
receive a database query at a master node or a compute node within a database system;
based on receiving the database query, identify a storage pool within the database system, the storage pool comprising a plurality of storage nodes, each storage node including a relational engine, a big data engine, and big data storage; and
process the database query over a combination of relational data stored within the database system and big data stored at the big data storage of at least one of the plurality of storage nodes.

2. The computer system as recited in claim 1, wherein the relational data is stored across the master node and a data pool comprising a plurality of data nodes.

3. The computer system as recited in claim 1, wherein the database query is received at the master node, and wherein the master node identifies the storage pool and processes the database query.

4. The computer system as recited in claim 1, wherein the database query is received at the master node, and wherein the master node passes the database query to a compute pool, which comprises a plurality of compute nodes, and wherein at least one of the plurality of compute nodes identifies the storage pool and processes the database query.

5. The computer system as recited in claim 1, wherein the database query is received at the master node, and wherein the master node stores the relational data.

6. The computer system as recited in claim 1, wherein the database query is received at the compute node, which is part of a compute pool comprising a plurality of compute nodes, and wherein at least one of the plurality of compute nodes identifies the storage pool and processes the database query.

7. The computer system as recited in claim 1, wherein the relational data is stored at a data pool comprising a plurality of data nodes, each data node including a relational engine and relational data storage.

8. The computer system as recited in claim 7, wherein processing the database query over a combination of relational data and big data comprises processing the database query in a distributed manner, in which:
a first compute node queries at least one of the plurality of storage nodes for the big data, and
a second compute node queries at least one of the plurality of data nodes for the relational data.

9. The computer system as recited in claim 1, wherein the master node receives a script for creating at least one of an artificial intelligence (AI) model or a machine learning (ML) model, and wherein the computer system processes the script over query results from processing the database query over a combination of relational data and big data to train or score the AI/ML model.

10. A computer system, comprising:
one or more processors; and
one or more computer-readable media having stored thereon computer-executable instructions that, when executed by the one or more processors, cause the computer system to perform the following:
receive, at a master node within a database system, a script for creating at least one of an artificial intelligence (AI) model or a machine learning (ML) model (AI/ML model);
based on receiving the script, identify a storage pool within the database system, the storage pool comprising a plurality of storage nodes, each storage node including a relational engine, a big data engine, and big data storage;
process the script over a combination of relational data stored within the database system and big data stored at the big data storage of at least one of the plurality of storage nodes to create the AI/ML model; and
based on a database query received at the master node, score the AI/ML model against data stored within the database system.

11. The computer system as recited in claim 10, wherein the relational data is stored at the master node.

12. The computer system as recited in claim 10, wherein the relational data is stored in a data pool comprising a plurality of data nodes, each data node including a relational engine and relational data storage.

13. The computer system as recited in claim 12, wherein processing the script comprises processing at least a portion of the script at a data node.

14. The computer system as recited in claim 12, wherein the AI/ML model is stored within a data node.

15. The computer system as recited in claim 14, wherein scoring the AI/ML model against data stored within the database system comprises the data node scoring the AI/ML model against data that is being stored at the data node.

16. The computer system as recited in claim 10, wherein processing the script comprises processing at least a portion of the script at each of a plurality of compute nodes in a compute pool.

17. The computer system as recited in claim 10, wherein processing the script comprises processing at least a portion of the script at each of the plurality of storage nodes.

18. The computer system as recited in claim 10, wherein the AI/ML model is stored at the master node.

19. The computer system as recited in claim 10, wherein scoring the AI/ML model against data stored within the database system comprises pushing the AI/ML model to a compute node, and wherein the compute node scores the AI/ML model against a partitioned portion of data received at the compute node.

20. A computer system, comprising:
one or more processors; and
one or more computer-readable media having stored thereon computer-executable instructions that, when executed by the one or more processors, cause the computer system to perform the following:
receive, at a master node within a database system, a script for creating at least one of an artificial intelligence (AI) model or a machine learning (ML) model (AI/ML model);
based on receiving the script, identify a storage pool within the database system, the storage pool comprising a plurality of storage nodes, each storage node including a relational engine, a big data engine, and big data storage;
process the script over a combination of relational data stored within the database system and big data stored at the big data storage of at least one of the plurality of storage nodes to create the AI/ML model;
receive a database query at the master node;
based on receiving the database query, identify the storage pool; and
process the database query to score the AI/ML model over the combination of relational data stored within the database system and big data stored at the big data storage of the at least one of the plurality of storage nodes.
